(19) United States
(12) Patent Application Publication
(10) Pub. No.: US 2024/0106170 A1
(43) Pub. Date: Mar. 28, 2024

(54) ELECTRICAL CONNECTOR

(71) Applicant: LOTES CO., LTD, Keelung (TW)

(72) Inventor: Yu Lun Tsai, Keelung (TW)

(21) Appl. No.: 18/367,522

(22) Filed: Sep. 13, 2023

(30) Foreign Application Priority Data
Sep. 23, 2022 (CN) 202211163018.4

(51) Int. Cl. H01R 13/6461; H01R 13/518; H01R 13/6588

(52) U.S. Cl. CPC H01R 13/6461; H01R 13/518; H01R 13/6588

(57) ABSTRACT

An electrical connector includes a metal body, signal terminals, and insulating blocks. The metal body has a mating cavity and accommodating slots. Each accommodating slot has a first metal wall and a second metal wall vertically opposite to each other and two third metal walls opposite to each other in a left-right direction. The second metal wall is provided with an opening. The accommodating slots are in communication with the mating cavity through the opening. Each signal terminal has a main body portion and an elastic arm. The main body portion is wrapped by an insulating member. The elastic arm is accommodated in a corresponding accommodating slot. The elastic arm includes a contact portion. The opening is reserved for the contact portion such that the contact portion enters the mating cavity. The insulating blocks pass forward beyond the rear wall. The insulating blocks are accommodated in the accommodating slots.

### CROSS-REFERENCE TO RELATED PATENT APPLICATION

This non-provisional application claims priority to and the benefit of, pursuant to 35 U.S.C. § 119(a), patent application Serial No. CN202211163018.4 filed in China on Sep. 23, 2022. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to an electrical connector, and particularly to an electrical connector facilitating transmission of high frequency signals.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

With the development of the electrical connector, the transmission speed of the signal terminals continues to increase, and the high frequency characteristics of the electrical connector becomes more important. In a traditional electrical connector, the signal terminal includes a main body portion and an elastic arm. The main body portion is wrapped by an insulating member, and the elastic arm has a portion completely exposed in the air, thus causing a large difference between the dielectric constant around the elastic arm and the dielectric constant around the main body portion, thereby resulting in a huge difference between the characteristic impedance values of the elastic arm and the main body portion, and a large return loss is herein generated in the transmission of high frequency signals, thus seriously affecting the high frequency characteristics of the electrical connector.

Therefore, a heretofore unaddressed need to design a new electrical connector exists in the art to address the aforementioned deficiencies and inadequacies.

### SUMMARY

The present invention is directed to an electrical connector, which may reduce the characteristic impedance of the elastic arm of each terminal, thereby enhancing the high frequency characteristics thereof.

To achieve the foregoing objective, the present invention adopts the following technical solutions.

An electrical connector includes: a metal body, having a mating cavity concavely provided backward from a front thereof and a plurality of accommodating slots located above and below the mating cavity, wherein the mating cavity has a rear wall, each of the accommodating slots is located in front of the rear wall, each of the accommodating slots has a first metal wall and a second metal wall vertically opposite to each other and two third metal walls opposite to each other in a left-right direction, the second metal wall is located closer to the mating cavity relative to the first metal wall, the second metal wall is provided with an opening, and the accommodating slots are in communication with the mating cavity through the opening; a plurality of signal terminals, wherein each of the signal terminals has a main body portion located behind the rear wall and an elastic arm extending forward from the main body portion and passing beyond the rear wall, the main body portion is wrapped by an insulating member, the elastic arm is accommodated in a corresponding one of the accommodating slots, the elastic arm includes a contact portion, and the opening is reserved for the contact portion such that the contact portion enters the mating cavity; and a plurality of insulating blocks, passing forward beyond the rear wall, wherein the insulating blocks are accommodated in the accommodating slots.

In certain embodiments, the insulating blocks comprise outer insulating blocks, each of the outer insulating blocks is located between the elastic arm and the first metal wall, each of the outer insulating block has an adjusting portion, the adjusting portion is located between the first metal wall and the contact portion, and when the mating component is inserted into the mating cavity, the contact portion pushes the adjusting portion to move altogether toward the first metal wall.

In certain embodiments, each of the outer insulating block has a plurality of adjusting portions, and each of the adjusting portions is located between the first metal wall and the contact portion.

In certain embodiments, each of the outer insulating blocks has a connecting portion, the connecting portion is pivoted to the metal body, the adjusting portion abuts against the contact portion, an activity space exists between the adjusting portion and the first metal wall, an abutting portion extends from the first metal wall, and the abutting portion enters the activity space to elastically abut against the adjusting portion.

In certain embodiments, the contact portion has an arc surface, a first oblique surface extending forward from the arc surface and facing away from the mating cavity, and a second oblique surface extending backward from the arc surface and facing away from the mating cavity, the first oblique surface, the arc surface and the second oblique surface form a concave portion, the adjusting portion protrudes into the concave portion, the adjusting portion has a connecting surface, a third oblique surface extending forward from the connecting surface and facing away from the mating cavity, and a fourth oblique surface extending backward from the connecting surface and facing away from the mating cavity, and the connecting surface and the arc surface abut against each other.

In certain embodiments, each of the insulating blocks has a stopping surface, the stopping surface is located at the opening, and the stopping surface is flush with the second metal wall.

In certain embodiments, the insulating blocks comprise inner insulating blocks, each of the inner insulating blocks is located behind the contact portion and is located between the elastic arm and the mating cavity, and each of the inner insulating blocks has the stopping surface.

In certain embodiments, the insulating blocks are provided to be clamped between the first metal wall and the insulating member.

In certain embodiments, the second metal wall and the third metal walls are integral, the first metal wall and the second metal wall are separate, the signal terminals and the insulating blocks are installed in the accommodating slots from a location of the first metal wall; at least one of the third metal walls has a recess, at least one of the insulating blocks has a connecting portion, and the connecting portion is provided to be clamped between the recess and the first metal wall.

In certain embodiments, a receiving slot is provided between two adjacent ones of the accommodating slots, the receiving slot accommodates a ground terminal, the ground terminal and the third metal walls abut against each other, the ground terminal has a mating portion protruding into the mating cavity, a left surface and a right surface of the mating portion are plate surfaces, and an upper surface and a lower surface of the elastic arm are plate surfaces.

An electrical connector includes: a metal body, configured for being inserted backward by a mating component, wherein the metal body has a plurality of accommodating slots, and each of the accommodating slots has a first metal wall and a second metal wall vertically opposite to each other and two third metal walls opposite to each other in a left-right direction; a plurality of signal terminals, wherein each of the signal terminals has a main body portion and an elastic arm extending forward from the main body portion, the main body portion is wrapped by an insulating member, the elastic arm is accommodated in a corresponding one of the accommodating slots, and the elastic arm has a mating surface to be in contact with the mating component; and a plurality of outer insulating blocks, accommodated in the accommodating slots, wherein each of the outer insulating blocks has an adjusting portion, the adjusting portion is located at one side of the elastic arm facing away from the mating surface, and when the mating component is inserted backward into the metal body, the elastic arm pushes the adjusting portion to move altogether toward the first metal wall.

In certain embodiments, each of the outer insulating blocks has a plurality of adjusting portions, and each of the adjusting portions is located at one side of the elastic arm facing away from the mating surface.

In certain embodiments, each of the outer insulating block further comprises a connecting portion, the connecting portion is pivoted to the metal body, the elastic arm comprises a contact portion, the mating surface is provided on the contact portion to be mated with the mating component, the adjusting portion abuts against the contact portion, an activity space exists between the adjusting portion and the first metal wall, an abutting portion extends from the first metal wall, and the abutting portion enters the activity space to elastically abut against the adjusting portion.

In certain embodiments, the electrical connector further includes a plurality of inner insulating blocks, wherein each of the inner insulating blocks is located between a plane on which the second metal wall is located and the elastic arm.

In certain embodiments, the second metal wall has an opening, each of the inner insulating blocks is located behind the mating surface, each of the inner insulating blocks has a stopping surface, the stopping surface is located at the opening, and the stopping surface is flush with the second metal wall.

In certain embodiments, the second metal wall and the third metal walls are integral, the first metal wall and the second metal wall are separate, the signal terminals and the outer insulating blocks are installed in the accommodating slots from a location of the first metal wall, at least one of the third metal walls has a recess, at least one of the outer insulating blocks has a connecting portion, and the connecting portion is provided to be clamped between the recess and the first metal wall.

In certain embodiments, a receiving slot is provided between two adjacent ones of the accommodating slots, the receiving slot accommodates a ground terminal, the ground terminal and the third metal walls abut against each other, the ground terminal has a mating portion to be mated with the mating component, a left surface and a right surface of the mating portion are plate surfaces, and an upper surface and a lower surface of the elastic arm are plate surfaces.

An electrical connector includes: a body, configured for being inserted backward by a mating component, wherein the body has a plurality of accommodating slots, and each of the accommodating slots has a first wall; a plurality of signal terminals, wherein each of the signal terminals has a main body portion and an elastic arm extending forward from the main body portion, the main body portion is wrapped by an insulating member, the elastic arm is accommodated in a corresponding one of the accommodating slots, and the elastic arm has a mating surface to be in contact with the mating component; and a plurality of outer insulating blocks, accommodated in the accommodating slots, wherein each of the outer insulating blocks has an adjusting portion, the adjusting portion is located at one side of the elastic arm facing away from the mating surface, the first wall is located at one side of the adjusting portion facing away from the elastic arm, an activity space exists between the adjusting portion and the first wall, and when the mating component is inserted backward into the body, the elastic arm pushes the adjusting portion to move altogether toward the first wall.

In certain embodiments, each of the outer insulating blocks has a plurality of adjusting portions, and each of the adjusting portions is located at one side of the elastic arm facing away from the mating surface.

In certain embodiments, each of the outer insulating block has a connecting portion, the connecting portion is pivoted to the body, the adjusting portion abuts against the elastic arm, the first wall is provided with an abutting portion, and the abutting portion enters the activity space to elastically abut against the adjusting portion.

Compared to the related art, the electrical connector according to certain embodiments of the present invention has the following beneficial effects:

The first metal wall, the second metal wall and the two third metal walls shield the signal terminals in various directions, thus enhancing the shielding effect to a maximized degree.

The dielectric constant of each insulating block is greater than that of the air. According to the formula

$$C = {ε}_{0} {ε}_{1} \frac{S}{d} ,$$

where C is a capacitance, ε₀ is the dielectric constant of the air, and ε₀ is the dielectric constant of other medium, and the formula

$${Z}_{characteristic impedance} = \sqrt{\frac{L}{C}} ,$$

it is understood that, by providing the insulating block adjacent to the elastic arm, the capacitance of the elastic arm may be increased, thereby reducing the characteristic impedance of the elastic arm, such that the characteristic impedance of the elastic arm is approximate to the characteristic impedance of the main body portion, preventing the high frequency signals from generating excessive return losses at this location, and enhancing the high frequency characteristics of the electrical connector.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective schematic view of an electrical connector according to a first embodiment of the present invention.

FIG. 2 is a perspective disassembled view of the electrical connector according to the first embodiment of the present invention.

FIG. 3 is a sectional view of the electrical connector according to the first embodiment of the present invention.

FIG. 4 is a schematic view of FIG. 3 after inserting a mating component therein.

FIG. 5 is an enlarged schematic view of a portion A in FIG. 4.

FIG. 6 is a partial perspective sectional view of the electrical connector according to the first embodiment of the present invention.

FIG. 7 is a perspective disassembled view of an electrical connector according to a second embodiment of the present invention.

FIG. 8 is a perspective schematic view of the electrical connector according to the second embodiment of the present invention.

FIG. 9 is a sectional view of the electrical connector according to the second embodiment of the present invention.

FIG. 10 is a schematic view of FIG. 9 after inserting a mating component therein.

FIG. 11 is an enlarged schematic view of a portion B in FIG. 10.

FIG. 12 is a perspective disassembled view of an electrical connector according to a third embodiment of the present invention.

FIG. 13 is a perspective schematic view of the electrical connector according to the third embodiment of the present invention.

FIG. 14 is a sectional view of the electrical connector according to the third embodiment of the present invention.

FIG. 15 is a schematic view of FIG. 14 after inserting a mating component therein.

FIG. 16 is an enlarged schematic view of a portion C in FIG. 15.

FIG. 17 is a perspective disassembled view of an electrical connector according to a fourth embodiment of the present invention.

FIG. 18 is a perspective schematic view of the electrical connector according to the fourth embodiment of the present invention.

FIG. 19 is a sectional view of the electrical connector according to the fourth embodiment of the present invention.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

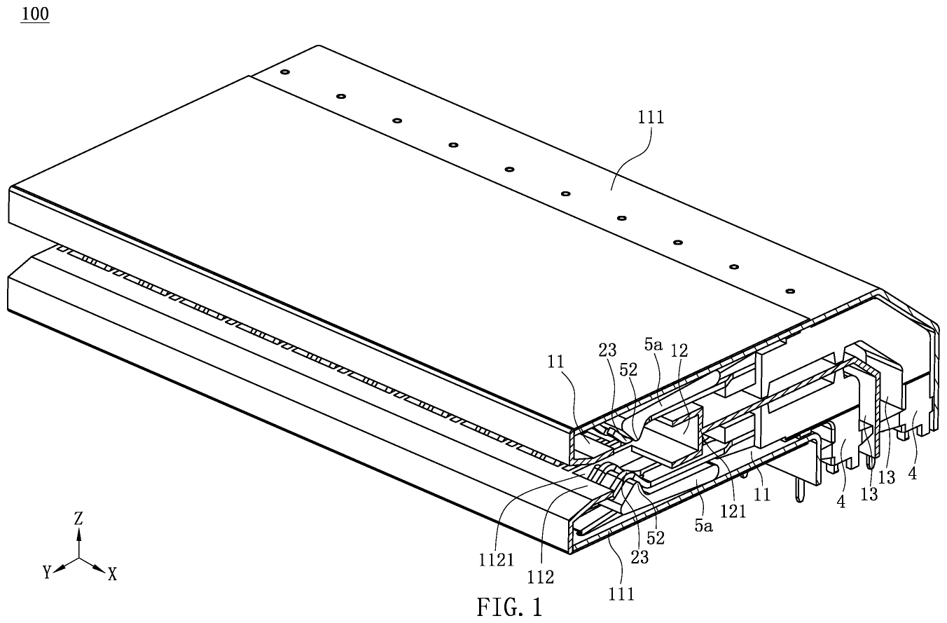

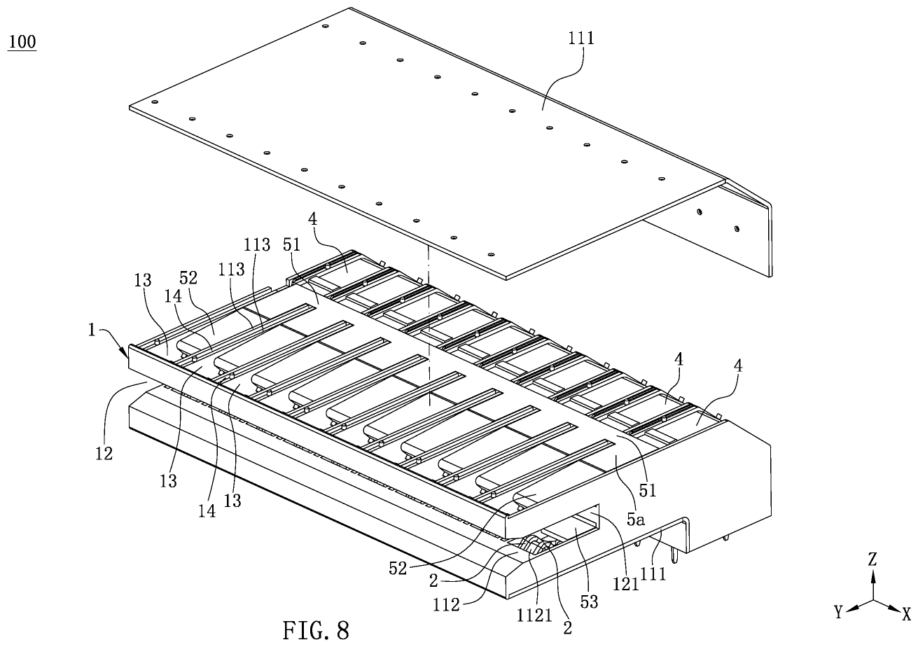

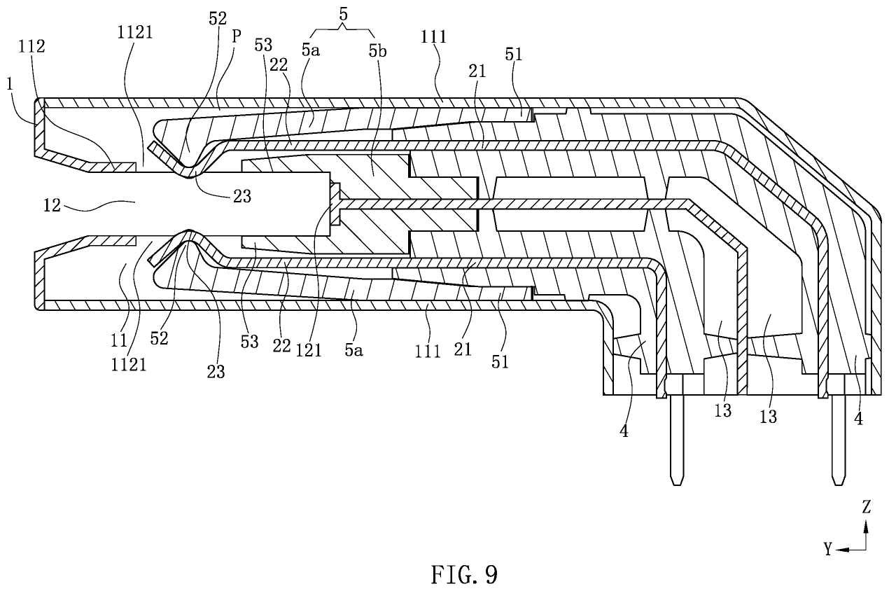

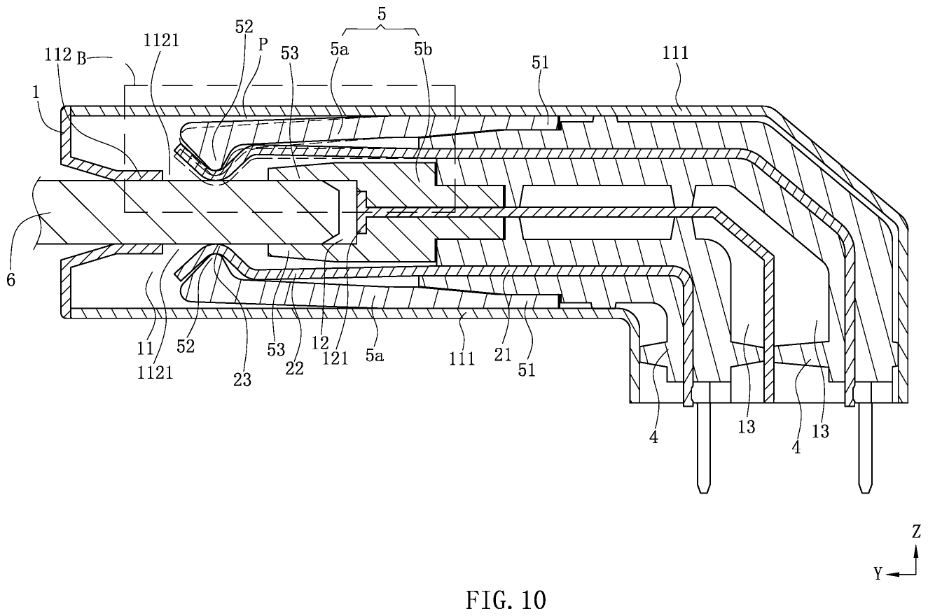

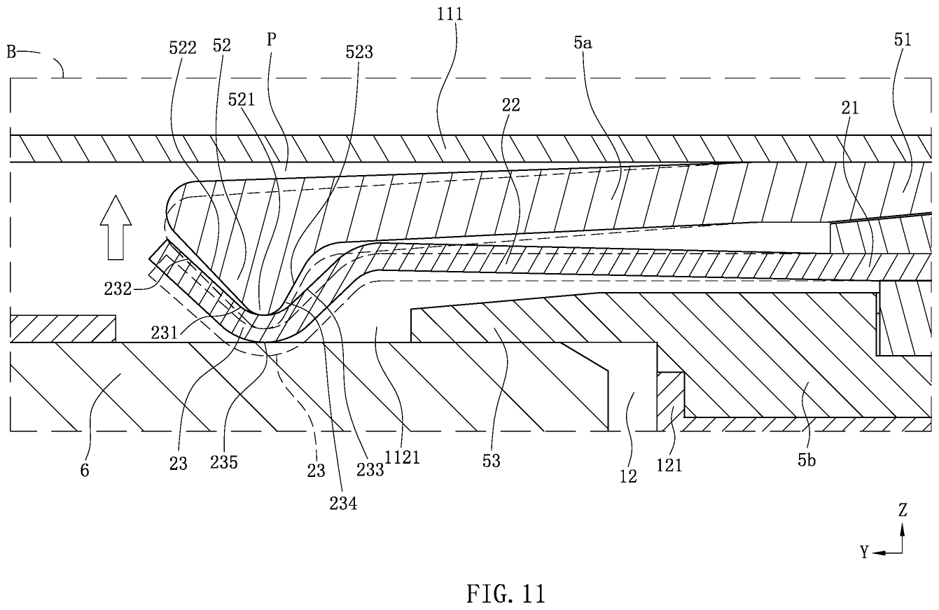

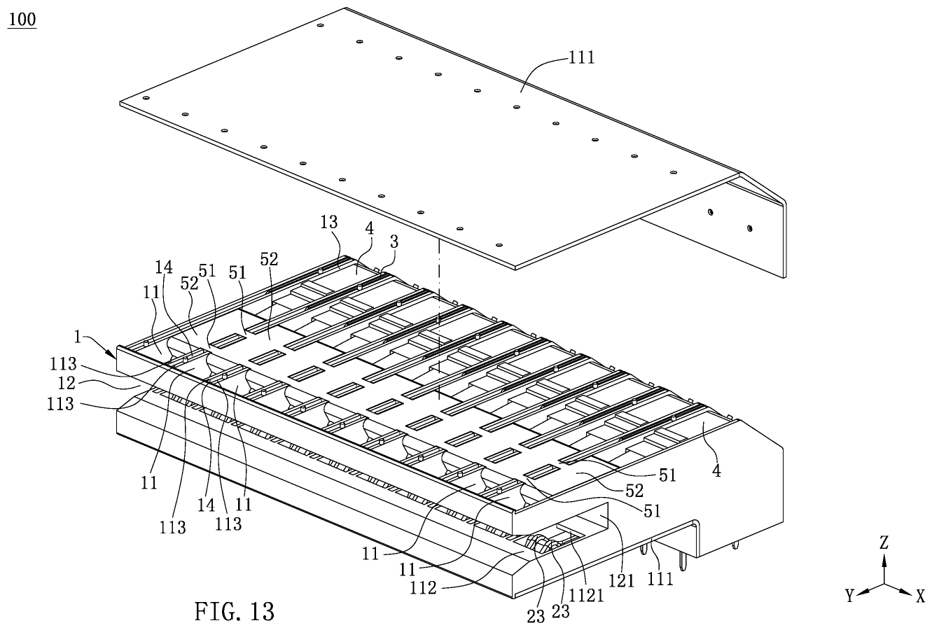

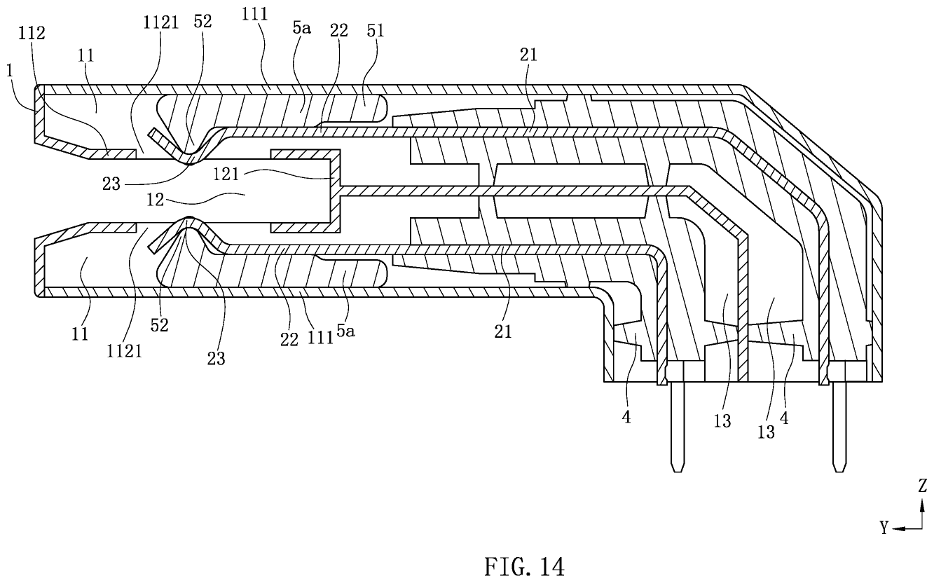

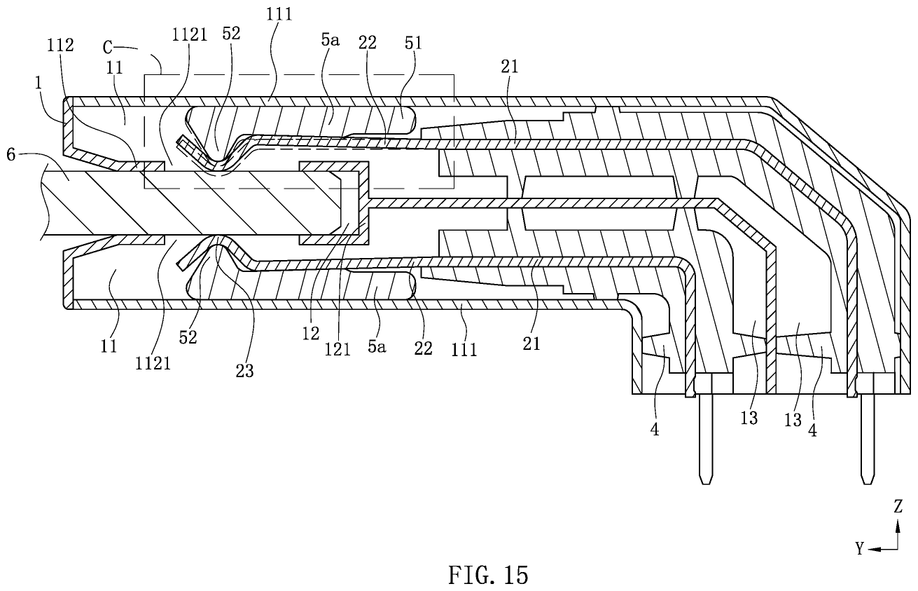

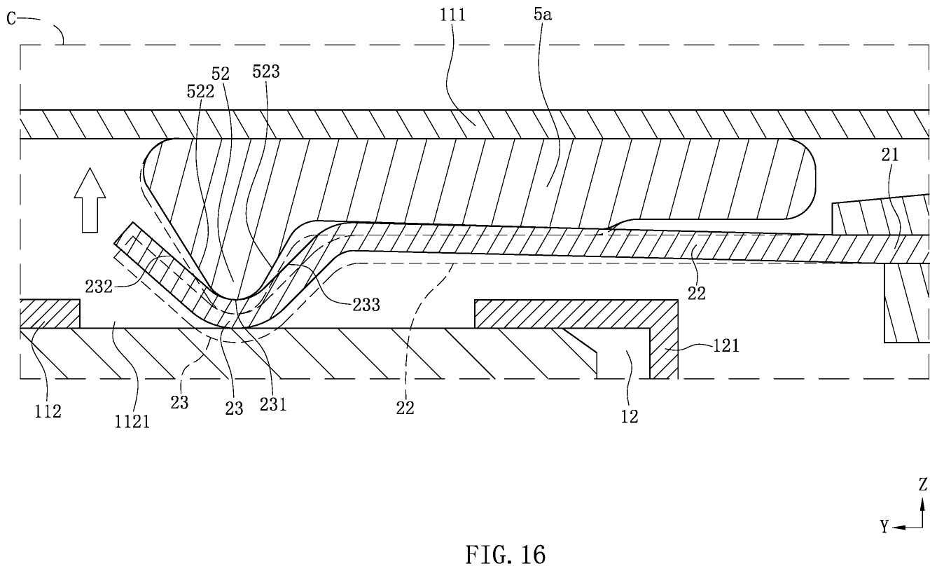

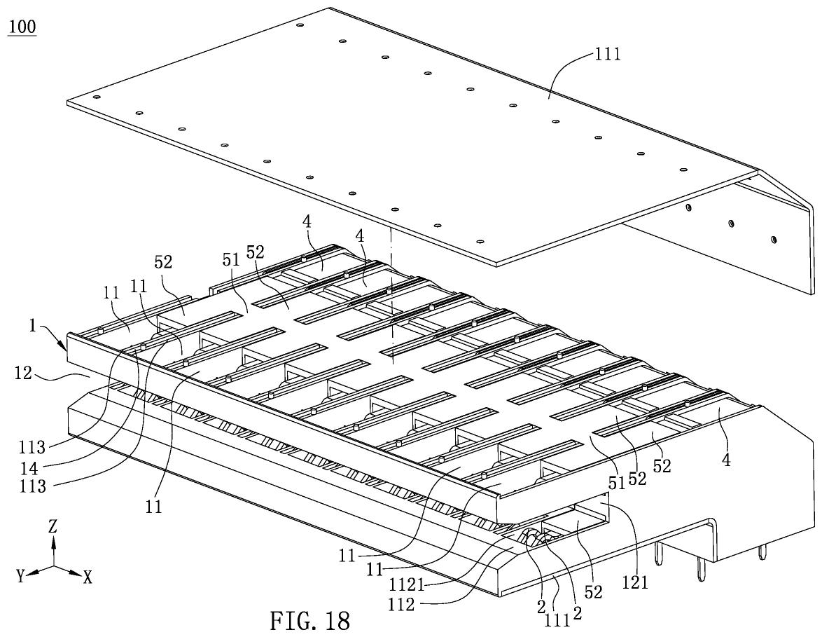

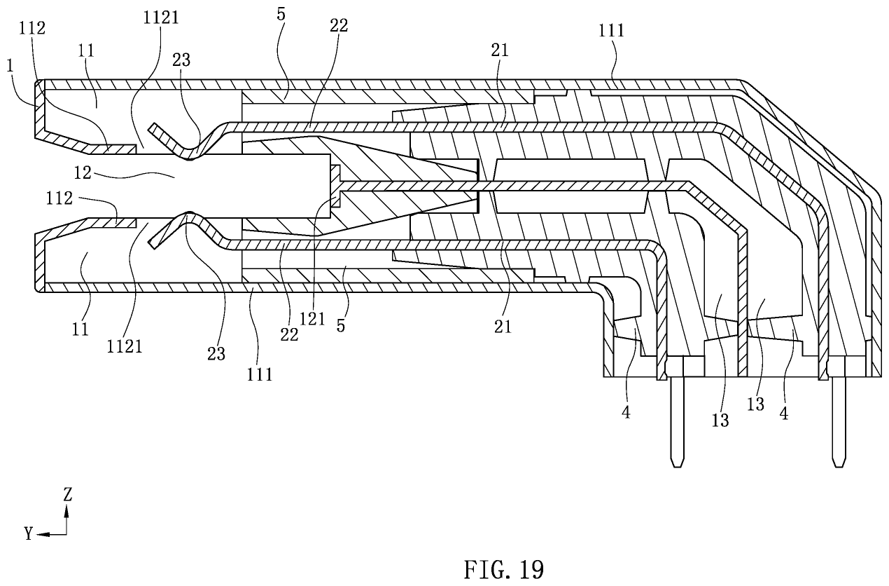

The description will be made as to the embodiments of the present invention in conjunction with the accompanying drawings in FIGS. 1-19. In accordance with the purposes of this invention, as embodied and broadly described herein, this invention, in one aspect, relates to an electrical connector.

In the directions related to the present invention, a left-right direction is represented by an X-axis, where the leftward direction is a positive direction of the X-axis; a front-rear direction is represented by a Y-axis, where the forward direction is a positive direction of the Y-axis; and a vertical direction is represented by a Z-axis, where the upward direction is a positive direction of the Z-axis.

FIG. 1 to FIG. 6 show an electrical connector 100 according to a first embodiment of the present invention.

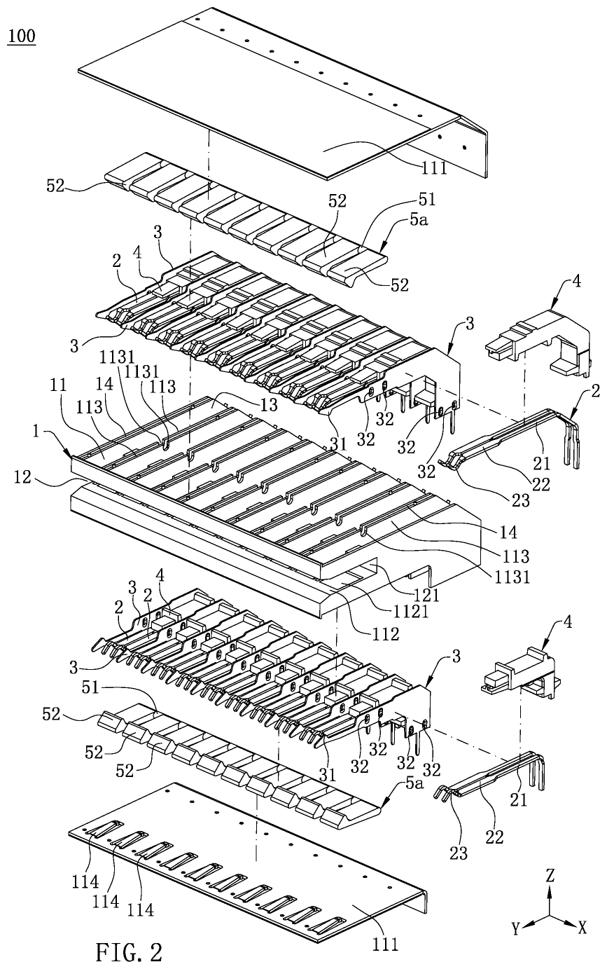

As shown in FIG. 1 and FIG. 2, the electrical connector 100 includes a metal body 1, a plurality of signal terminals 2 and a plurality of ground terminals 3, an insulating member 4 wrapping the signal terminals 2, and a plurality of insulating blocks 5 used to adjust the characteristic impedance of the signal terminals 2. The insulating blocks 5 include only outer insulating blocks 5a.

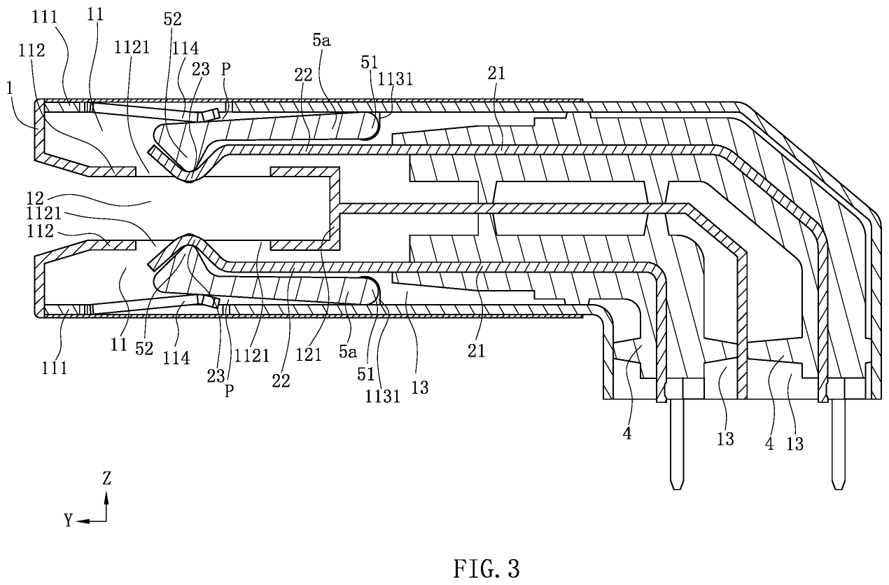

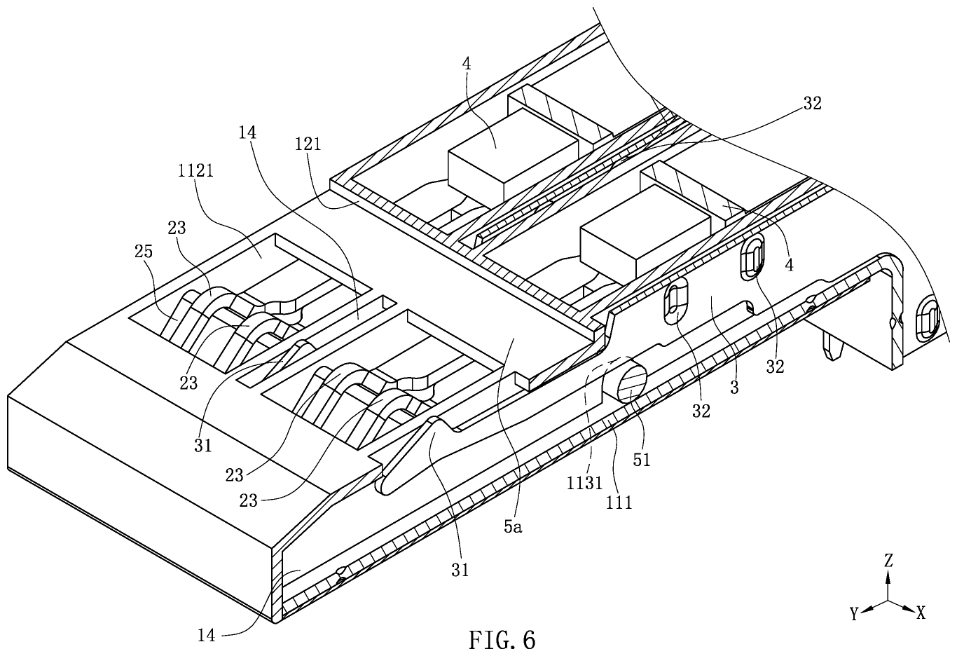

As shown in FIG. 2, FIG. 3 and FIG. 6, the metal body 1 is made of a metal material by powder metallurgy, and has a mating cavity 12 concavely provided backward from a front thereof and a plurality of accommodating slots 11 located above and below the mating cavity 12. The mating cavity 12 is used for a mating component 6 to be inserted backward therein and has a rear wall 121. Each accommodating slot 11 is located in front of the rear wall 121. An accommodating channel 13 extends backward from each accommodating slot 11. Each accommodating slot has a first metal wall 111 and a second metal wall 112 vertically opposite to each other and two third metal walls 113 opposite to each other in the left-right direction, and the second metal wall 112 is located closer to the mating cavity 12 relative to the first metal wall 111. The second metal wall 112 is provided with an opening 1121, and the accommodating slots 11 are in communication with the mating cavity 12 through the opening 1121. A receiving slot 14 is provided between two adjacent accommodating slots 11, and the receiving slot 14 and each accommodating slot 11 are separated by one of the third metal walls 113. Each third metal wall 113 has a recess 1131.

In the present embodiment, the metal body 1 is a one-piece type. In other embodiments, the metal body 1 may be formed by assembling a plurality of metal units. Specifically, the mating cavity 12 of the electrical connector 100 according to the present embodiment of the present invention, but in other embodiments, the mating cavity 12 may be formed by assembling the metal units. Further, in other embodiments, the body 1 of the electrical connector does not need to be a metal body, and may be a plastic body made of plastic.

As shown in FIG. 2 and FIG. 3, each signal terminal 2 includes a main body portion 21 located behind the rear wall 121 and an elastic arm 22 extending forward from the main body portion 21 and passing beyond the rear wall 121. In the present embodiment, two adjacent signal terminals 2 form a differential signal terminal pair, and the two main body portions 21 of a differential signal terminal pair are wrapped by a same insulating member 4 by insert-molding (and in other embodiments, it is possible that an insulating member 4 wraps the main body portions 21 of a row of signal terminals 2, or an insulating member 4 wraps the main body portion 21 of one signal terminal 2), and the two main body portions 21 and the insulating member 4 are altogether accommodated in an accommodating channel 13. The two elastic arms 22 of the differential signal terminal pair are altogether accommodated in an accommodating slot 11. Each elastic arm 22 includes a contact portion 23, and the contact portion 23 enters the mating cavity 12. The contact portion 23 has a mating surface 235 and an arc surface 231 provided opposite to each other, a first oblique surface 232 extending forward from the arc surface 231 and facing away from the mating cavity 12, and a second oblique surface 233 extending backward from the arc surface 231 and facing away from the mating cavity 12. The first oblique surface 232, the arc surface 231 and the second oblique surface 233 form a concave portion 234, and the mating surface 235 is located in the mating cavity 12 to be mated with the mating component 6.

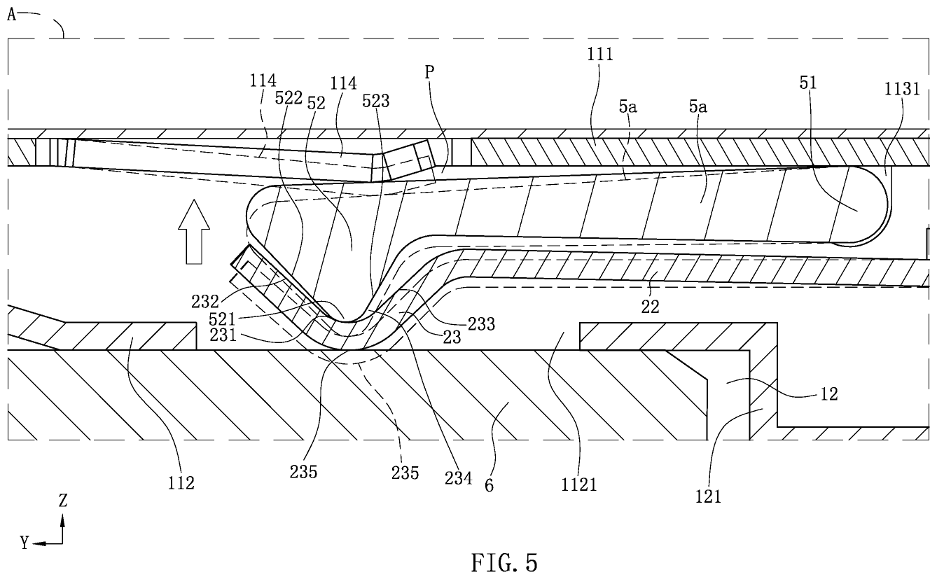

As shown in FIG. 2, FIG. 3 and FIG. 5, the outer insulating blocks 5a pass forward beyond the rear wall 121, and parts of the outer insulating blocks 5a are accommodated in the accommodating slots 11. The outer insulating block 5a have a plurality of adjusting portions 52 arranged in a row along the left-right direction and a connecting portion 51. Each adjusting portion 52 is located between the first metal wall 111 and the contact portion 23 and protrudes into the concave portion 234. Each adjusting portion 52 has a connecting surface 521, a third oblique surface 522 extending forward from the connecting surface 521 and facing away from the mating cavity 12, and a fourth oblique surface 523 extending backward from the connecting surface 521 and facing away from the mating cavity 12. The connecting surface 521 and the arc surface 231 abut against each other.

In the present embodiment, a row of the signal terminals 2 only corresponds to one of the outer insulating blocks 5a, and each outer insulating block 5a has only one connecting portion 51, where the connecting portion 51 is provided to be clamped and pivoted between the recess 1131 and the first metal wall 111. However, in other embodiments, a row of the signal terminals 2 may correspond to multiple outer insulating blocks 5a.

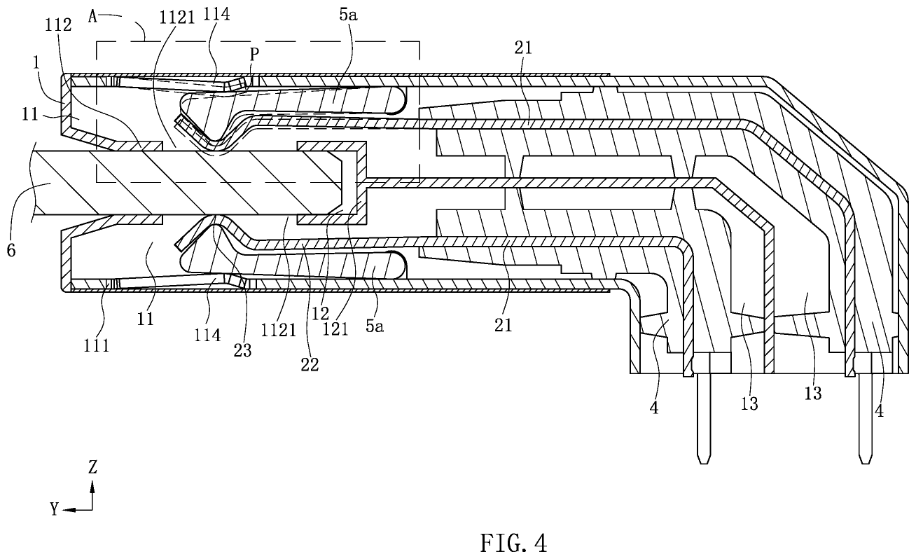

As shown in FIG. 3, FIG. 4 and FIG. 5, an activity space P exists between the adjusting portion 52 and the first metal wall 111. An abutting portion 114 extends from the first metal wall 111 toward the activity space P, and the abutting portion 114 elastically abuts against the adjusting portion 52. When the mating component 6 is mated with the electrical connector 100, the contact portion 23 is pressed by the mating component 6 to move toward the first metal wall 111, and the contact portion 23 pushes the adjusting portion 52 to rotate. In the whole process, the abutting portion 114 continues elastically abutting against the adjusting portion 52, such that the connecting surface 521 elastically abuts against the arc surface 231, allowing the contact portion 23 to have a stronger pressure on the mating component 6, and the contact between the contact portion 23 and the mating component 6 is more stable.

As shown in FIG. 2 and FIG. 6, each ground terminal 3 is accommodated in a receiving slot 14. Each ground terminal 3 includes a mating portion 31 and a plurality of protruding portions 32. The mating portion 31 protrudes into the mating cavity 12 to be mated with the mating component 6, and the protruding portions 32 abut against the third metal walls 113. An upper surface and a lower surface of the contact portion 23 are plate surfaces (in other words, the contact portion 23 of each signal terminal 2 is provided horizontally), and a left surface and a right surface of the mating portion 31 are plate surface (in other words, the mating portion 31 of each ground terminal 3 is provided vertically).

As shown in FIG. 1 and FIG. 2, the second metal wall 112 and the third metal walls 113 are integral, and the first metal wall 111 and the third metal walls 113 are separate. This type of structure allows the assembly of the electrical connector 100 to be relatively convenient. Specifically, the first metal wall 111 is formed by two metal plates attached with each other and assembled onto the third metal walls 113, in which one metal plate is torn to form the abutting portion 114, and the other metal plate covers the abutting portion 114. In the assembly process of the electrical connector 100, the differential signal terminal pair, the insulating member 4 and the outer insulating blocks 5a are installed in the accommodating slots 11 and the accommodating channels 13 from the location of the first metal wall 111, and the ground terminals 3 are installed into the receiving slots 14 from the location of the first metal wall 111. Finally, the first metal wall 111 is covered, such that the peripheries of the accommodating slots 11 and the accommodating channels 13 are blocked by the metal walls, thus shielding the signal terminals 2 in multiple directions, and enhancing the shielding effect. In other embodiments, the metal body 1 may be without the mating cavity 12, and the second metal wall 112 is not provided with the opening 1121. Instead, an opening is provided in front of the accommodating slots 11 for the mating component 6 to enter each accommodating slot 11 backward from a front thereof to be mated with the contact portion 23.

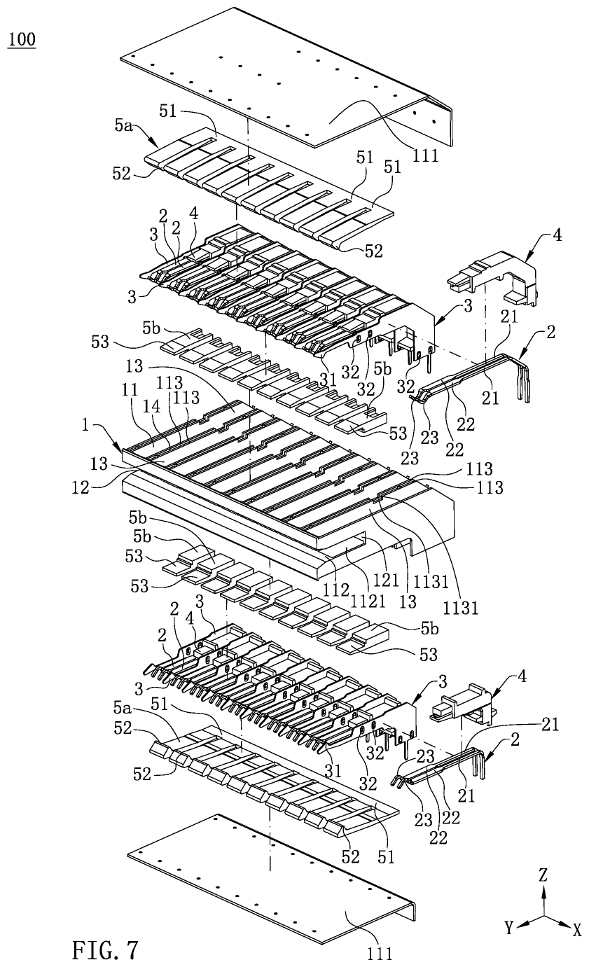

FIG. 7 to FIG. 11 show an electrical connector 100 according to a second embodiment of the present invention, which is different from the first embodiment in that each third metal wall 113 is formed by a metal plate, and each third metal wall 113 is not torn to form the abutting portion 114. The insulating blocks 5 include, in addition to the outer insulating blocks 5a, the inner insulating blocks 5b. The connecting portion 51 is clamped and fixed by the first metal wall 111 and the insulating member 4 (and in other embodiments, the connecting portion 51 may be fixed between the first metal wall 111 and the insulating member 4 by insert-molding). When the mating component 6 is mated with the electrical connector 100, the contact portion 23 is pressed by the mating component 6, and the contact portion 23 presses the adjusting portion 52, such that the outer insulating blocks 5a are elastically deformed, and the contact portion 23 and the adjusting portion 52 altogether move toward the first metal wall 111. Each inner insulating blocks 5b is located behind the contact portion 23 and located between the elastic arm 22 and the mating cavity 12. Specifically, each inner insulating block 5b is located between the elastic arm 22 and a plane on which the second metal wall 112 is located. Each inner insulating block 5b has a stopping surface 53, and the stopping surface 53 is located at the opening 1121 and is flush with the second metal wall 112. Other structures are identical to those in the first embodiment, and are thus not hereinafter elaborated.

Further, the inner insulating blocks 5b of the present embodiment is not only suited for the present embodiment, but also may be used in other embodiments. For example, in the first embodiment, the inner insulating blocks 5b may be added at the location behind the contact portion 23 between the elastic arm 22 and the second metal wall 112.

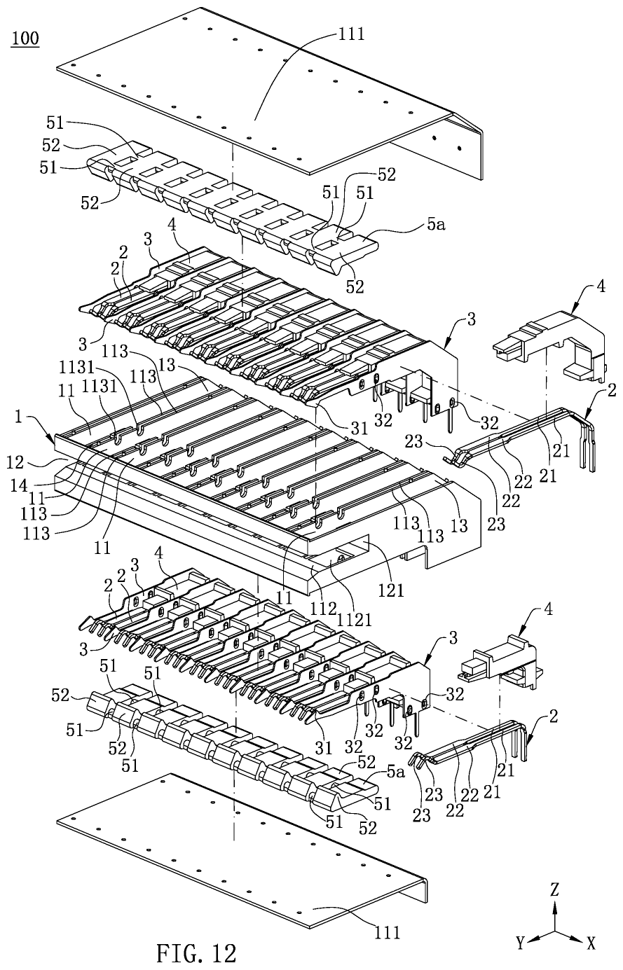

FIG. 12 to FIG. 16 show an electrical connector 100 according to a third embodiment of the present invention, which is different from the second embodiment in that the insulating blocks 5 include only the outer insulating blocks 5a. Each outer insulating block 5a is an elastic body capable of being elastically compressed. Specifically, the material of the elastic body may be silicone rubber (and in other embodiments, it may be other insulating elastic materials), and the adjusting portion 52 abuts against the first metal wall 111. When the mating component 6 is mated with the electrical connector 100, the contact portion 23 is pressed by the mating component 6 to move toward the first metal wall 111, and the contact portion 23 presses the adjusting portion 52, allowing the adjusting portion 52 to be elastically compressed, such that the size of the adjusting portion 52 becomes smaller along the vertical direction. Other structures are identical to those in the second embodiment, and are thus not hereinafter elaborated.

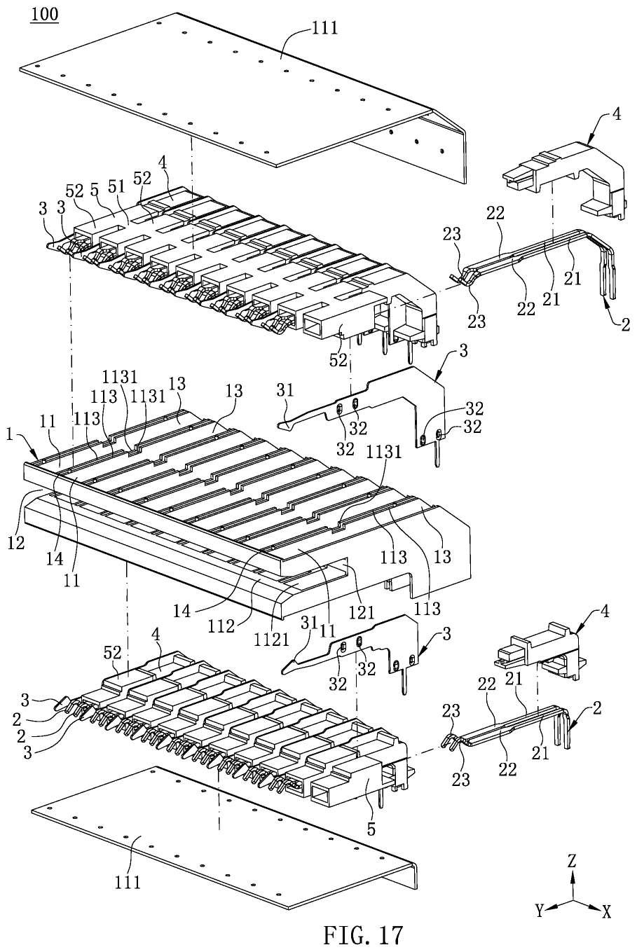

FIG. 17 to FIG. 19 show an electrical connector 100 according to a fourth embodiment of the present invention, which is different from the first embodiment in that each third metal wall 113 is formed by a metal plate, and each third metal wall 113 is not torn to form the abutting portion 114. Each insulating block 5 is a sleeve insulating block. The sleeve insulating block is sleeved outside the insulating member 4 and abuts against the first metal wall 111. The sleeve insulating block is located behind the contact portion 23 and surrounds the periphery of the elastic arm 22 in upward, downward, leftward and rightward directions. Gaps exist between the elastic arm 22 and the sleeve insulating block in the upward, downward, leftward and rightward directions, such that when the contact portion 23 is pressed by the mating component 6 to move, it is not blocked by the sleeve insulating block. Further, the sleeve insulating block has a stopping surface 53, and the stopping surface 53 is located at the opening 1121 and is flush with the second metal wall 112.

In sum, certain embodiments of the present invention have the following beneficial effects:

1. The first metal wall 111, the second metal wall 112 and the two third metal walls 113 are in communication with one another, thus shielding the signal terminals 2 in various directions, and enhancing the shielding effect to a maximized degree, and thereby resolving the crosstalk issue between the signal terminals 2.

When each signal terminal 2 transmits signals, the elastic arm 22 protrudes out of the insulating block 4 and is exposed in the air, and the dielectric constant of the air is relatively low. According to the formula

$$C = {ε}_{0} {ε}_{1} \frac{S}{d}$$

(where C is a capacitance, ε₀ is the dielectric constant of the air, and ε₀ is the dielectric constant of other medium), when the elastic arm 22 is exposed in the air, the capacitance at the location of the elastic arm 22 is lower than the capacitance of the main body portion 21. According to the formula

$${Z}_{characteristic impedance} = \sqrt{\frac{L}{C}} ,$$

it is understood that, in each signal terminal 2, the characteristic impedance at the elastic arm 22 is higher than the characteristic impedance of the main body portion 21. The dielectric constant of the insulating block 5 is greater than that of the air, and by providing the insulating block 5 adjacent to the elastic arm 22, the capacitance of the elastic arm 22 may be increased, thereby reducing the characteristic impedance of this portion, such that it is approximate to the characteristic impedance of the main body portion 21, thus preventing the high frequency signals from generating excessive return losses at this location, and enhancing the high frequency characteristics of the electrical connector 100.

2. When the mating component 6 is inserted therein, the contact portion 23 pushes the adjusting portion 52 to move toward the first metal wall 111. The contact portion 23 abuts against the adjusting portion 52, and the adjusting portion 52 gives the contact portion 23 a pressure directed toward the mating component 6. This pressure allows the contact between the contact portion 23 and the mating component 6 to be more intact, and in an environment under impact or vibration, there is no sudden break between the contact portion 23 and the mating component 6.

In the first embodiment, the connecting portion 51 is provided to be clamped and pivoted between the recess 1131 and the first metal wall 111. The abutting portion 114 protrudes into the activity space P and elastically abuts against the adjusting portion 52, and the adjusting portion 52 elastically abuts against the contact portion 23, such that when the contact portion 23 moves toward the first metal wall 111, the contact portion 23 simultaneously pushes the adjusting portion 52 to rotate. The insulating block 5 and the signal terminal 2 move in synchronization, such that a distance between the outer insulating block 5a and the signal terminal 2 does not change. When the contact portion 23 moves, the dielectric constant surrounding the elastic arm 22 does not change, such that the characteristic impedance of the signal terminal 2 is stable before and after the mating component 6 is inserted therein.

Meanwhile, the connecting surface 521 and the arc surface 231 abut against each other. By the matching of the first oblique surface 232, the second oblique surface 233, the third oblique surface 522 and the fourth oblique surface 523, the normal facing area of the contact portion 23 and the adjusting portion 52 is increased, and in the case where other conditions are identical, the capacitance of the contact portion 23 may be increased, such that the adjusting effect of the adjusting portion 52 to the characteristic impedance of the contact portion 23 is better.

3. An inner insulating block 5b is further provided between the elastic arm 22 and a plane on which the second metal wall 112 is located, thus further adjusting the dielectric constant surrounding the elastic arm 22, and the inner insulating block 5b may prevent the elastic arm 22 from being in contact with the second metal wall 112 and short-circuiting.

Further, the stopping surface 53 is located at the opening 1121 and is flush with the second metal wall 112, such that when the mating component 6 is inserted into the mating cavity 12, it is stopped by the stopping surface 53, which essentially reduces the area of the opening 1121, such that the mating component 6 cannot enter the accommodating slot 11 from the opening 1121 and damage the signal terminal 2 therein, and the insertion of the mating component 6 is more stable and safe. In addition, compared to the case where the area of the second metal wall 112 is increased, by the method of stopping the mating component by the second metal wall 112, the inner insulating block 5b is an insulating material, which may be in contact with the metal portion of the mating component 6 without short-circuiting, thus enhancing the fault tolerance rate.

4. In the fourth embodiment, each insulating block 5 is a sleeve insulating block. The sleeve insulating block sleeves the elastic arm 22, thus preventing the elastic arm 22 from being in contact with the first metal wall 111, the second metal wall 112 and the third metal walls 113 and short-circuiting. The existence of the gaps may further allow the elastic arm 22 to elastically deform in the direction toward the first metal wall 111 when the mating component 6 is inserted therein, and the mating component 6 may be inserted into the mating cavity 12 smoothly.

5. Each ground terminal 3 is located in the receiving slot 14, and the left surface and the right surface of the ground terminal 3 are plate surfaces, and the upper surface and the lower surface of the elastic arm 22 are plate surfaces. Due to the existence of the insulating block 5, the size of each ground terminal 3 along the vertical direction is approximate to the size of the insulating block 5 plus the signal terminal 2 along the vertical direction, and in the case where the ground terminal 3 and the signal terminal 2 are arranged in a row, the spaces of the receiving slot 14 and the accommodating slot 11 may be utilized to a maximized degree, thereby reducing the volume of the electrical connector 100. Meanwhile, the two accommodating slots 11 are separated by the two third metal walls 113, and the ground terminal 3 is provided between the two third metal walls 113, thus increasing the thickness of the shielding layer to a maximized degree. With this type of structure, it is difficult for the adjacent signal terminal pairs to affect each other. Further, the ground terminal 3 and the third metal walls 113 abut against each other, and the metal body 1 and the ground terminal 3 are electrically connected, such that the whole metal body 1 is grounded in operation.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, comprising:
a metal body, having a mating cavity concavely provided backward from a front thereof and a plurality of accommodating slots located above and below the mating cavity, wherein the mating cavity has a rear wall, each of the accommodating slots is located in front of the rear wall, each of the accommodating slots has a first metal wall and a second metal wall vertically opposite to each other and two third metal walls opposite to each other in a left-right direction, the second metal wall is located closer to the mating cavity relative to the first metal wall, the second metal wall is provided with an opening, and the accommodating slots are in communication with the mating cavity through the opening;
a plurality of signal terminals, wherein each of the signal terminals has a main body portion located behind the rear wall and an elastic arm extending forward from the main body portion and passing beyond the rear wall, the main body portion is wrapped by an insulating member, the elastic arm is accommodated in a corresponding one of the accommodating slots, the elastic arm comprises a contact portion, and the opening is reserved for the contact portion such that the contact portion enters the mating cavity; and
a plurality of insulating blocks, passing forward beyond the rear wall, wherein the insulating blocks are accommodated in the accommodating slots.

2. The electrical connector according to claim 1, wherein the insulating blocks comprise outer insulating blocks, each of the outer insulating blocks is located between the elastic arm and the first metal wall, each of the outer insulating block has an adjusting portion, the adjusting portion is located between the first metal wall and the contact portion, and when the mating component is inserted into the mating cavity, the contact portion pushes the adjusting portion to move altogether toward the first metal wall.

3. The electrical connector according to claim 2, wherein each of the outer insulating block has a plurality of adjusting portions, and each of the adjusting portions is located between the first metal wall and the contact portion.

4. The electrical connector according to claim 2, wherein each of the outer insulating blocks has a connecting portion, the connecting portion is pivoted to the metal body, the adjusting portion abuts against the contact portion, an activity space exists between the adjusting portion and the first metal wall, an abutting portion extends from the first metal wall, and the abutting portion enters the activity space to elastically abut against the adjusting portion.

5. The electrical connector according to claim 2, wherein the contact portion has an arc surface, a first oblique surface extending forward from the arc surface and facing away from the mating cavity, and a second oblique surface extending backward from the arc surface and facing away from the mating cavity, the first oblique surface, the arc surface and the second oblique surface form a concave portion, the adjusting portion protrudes into the concave portion, the adjusting portion has a connecting surface, a third oblique surface extending forward from the connecting surface and facing away from the mating cavity, and a fourth oblique surface extending backward from the connecting surface and facing away from the mating cavity, and the connecting surface and the arc surface abut against each other.

6. The electrical connector according to claim 1, wherein each of the insulating blocks has a stopping surface, the stopping surface is located at the opening, and the stopping surface is flush with the second metal wall.

7. The electrical connector according to claim 6, wherein the insulating blocks comprise inner insulating blocks, each of the inner insulating blocks is located behind the contact portion and is located between the elastic arm and the mating cavity, and each of the inner insulating blocks has the stopping surface.

8. The electrical connector according to claim 1, wherein the insulating blocks are provided to be clamped between the first metal wall and the insulating member.

9. The electrical connector according to claim 1, wherein the second metal wall and the third metal walls are integral, the first metal wall and the second metal wall are separate, the signal terminals and the insulating blocks are installed in the accommodating slots from a location of the first metal wall; at least one of the third metal walls has a recess, at least one of the insulating blocks has a connecting portion, and the connecting portion is provided to be clamped between the recess and the first metal wall.

10. The electrical connector according to claim 1, wherein a receiving slot is provided between two adjacent ones of the accommodating slots, the receiving slot accommodates a ground terminal, the ground terminal and the third metal walls abut against each other, the ground terminal has a mating portion protruding into the mating cavity, a left surface and a right surface of the mating portion are plate surfaces, and an upper surface and a lower surface of the elastic arm are plate surfaces.

11. An electrical connector, comprising:
a metal body, configured for being inserted backward by a mating component, wherein the metal body has a plurality of accommodating slots, and each of the accommodating slots has a first metal wall and a second metal wall vertically opposite to each other and two third metal walls opposite to each other in a left-right direction;
a plurality of signal terminals, wherein each of the signal terminals has a main body portion and an elastic arm extending forward from the main body portion, the main body portion is wrapped by an insulating member, the elastic arm is accommodated in a corresponding one of the accommodating slots, and the elastic arm has a mating surface to be in contact with the mating component; and
a plurality of outer insulating blocks, accommodated in the accommodating slots, wherein each of the outer insulating blocks has an adjusting portion, the adjusting portion is located at one side of the elastic arm facing away from the mating surface, and when the mating component is inserted backward into the metal body, the elastic arm pushes the adjusting portion to move altogether toward the first metal wall.

12. The electrical connector according to claim 11, wherein each of the outer insulating blocks has a plurality of adjusting portions, and each of the adjusting portions is located at one side of the elastic arm facing away from the mating surface.

13. The electrical connector according to claim 11, wherein each of the outer insulating block further comprises a connecting portion, the connecting portion is pivoted to the metal body, the elastic arm comprises a contact portion, the mating surface is provided on the contact portion to be mated with the mating component, the adjusting portion abuts against the contact portion, an activity space exists between the adjusting portion and the first metal wall, an abutting portion extends from the first metal wall, and the abutting portion enters the activity space to elastically abut against the adjusting portion.

14. The electrical connector according to claim 11, further comprising a plurality of inner insulating blocks, wherein each of the inner insulating blocks is located between a plane on which the second metal wall is located and the elastic arm.

15. The electrical connector according to claim 14, wherein the second metal wall has an opening, each of the inner insulating blocks is located behind the mating surface, each of the inner insulating blocks has a stopping surface, the stopping surface is located at the opening, and the stopping surface is flush with the second metal wall.

16. The electrical connector according to claim 11, wherein the second metal wall and the third metal walls are integral, the first metal wall and the second metal wall are separate, the signal terminals and the outer insulating blocks are installed in the accommodating slots from a location of the first metal wall, at least one of the third metal walls has a recess, at least one of the outer insulating blocks has a connecting portion, and the connecting portion is provided to be clamped between the recess and the first metal wall.

17. The electrical connector according to claim 11, wherein a receiving slot is provided between two adjacent ones of the accommodating slots, the receiving slot accommodates a ground terminal, the ground terminal and the third metal walls abut against each other, the ground terminal has a mating portion to be mated with the mating component, a left surface and a right surface of the mating portion are plate surfaces, and an upper surface and a lower surface of the elastic arm are plate surfaces.

18. An electrical connector, comprising:
a body, configured for being inserted backward by a mating component, wherein the body has a plurality of accommodating slots, and each of the accommodating slots has a first wall;
a plurality of signal terminals, wherein each of the signal terminals has a main body portion and an elastic arm extending forward from the main body portion, the main body portion is wrapped by an insulating member, the elastic arm is accommodated in a corresponding one of the accommodating slots, and the elastic arm has a mating surface to be in contact with the mating component; and
a plurality of outer insulating blocks, accommodated in the accommodating slots, wherein each of the outer insulating blocks has an adjusting portion, the adjusting portion is located at one side of the elastic arm facing away from the mating surface, the first wall is located at one side of the adjusting portion facing away from the elastic arm, an activity space exists between the adjusting portion and the first wall, and when the mating component is inserted backward into the body, the elastic arm pushes the adjusting portion to move altogether toward the first wall.

19. The electrical connector according to claim 18, wherein each of the outer insulating blocks has a plurality of adjusting portions, and each of the adjusting portions is located at one side of the elastic arm facing away from the mating surface.

20. The electrical connector according to claim 18, wherein each of the outer insulating block has a connecting portion, the connecting portion is pivoted to the body, the adjusting portion abuts against the elastic arm, the first wall is provided with an abutting portion, and the abutting portion enters the activity space to elastically abut against the adjusting portion.
